(19) United States
(12) Patent Application Publication
(10) Pub. No.: US 2008/0149039 A1
(43) Pub. Date: Jun. 26, 2008

(54) METHOD AND SYSTEM FOR PROMOTING LONGEVITY AND HEALTHY VITALITY OF A PET

(75) Inventors: Neil Willcocks, Brentwood, TN (US); Christopher Lewis Jones, Brentwood, TN (US)

Correspondence Address: FITZPATRICK CELLA HARPER & SCINTO, 30 ROCKEFELLER PLAZA, NEW YORK, NY, 10112, US

(73) Assignee: MARS, INCORPORATED, McLean, VA (US)

(21) Appl. No.: 11/958,754

(22) Filed: Dec. 18, 2007

Related U.S. Application Data
(60) Provisional application No. 60/876,302, filed on Dec. 20, 2006.

(51) Int. Cl. A01K 29/00

(52) U.S. Cl. 119/174

(57) ABSTRACT

In order to promote longevity and a healthy vitality of a pet, the pet's condition is assessed. For a pet that is overweight, a recommended food regimen is determined that takes into account the pet's lifestyle and pet feeding preferences of the pet's owner. The recommended food regimen reduces the daily calorie intake of the pet without significantly reducing the quantity of food consumed by the pet on a daily basis. The owner may select from a plurality of options for satisfying the food regimen. In this way, the owner can have an enhanced pet feeding experience by being able to provide the pet with a variety of different foods that help the pet to lose weight.

### CROSS-REFERENCE TO RELATED APPLICATIONS

The present application claims benefit of U.S. Provisional Patent Application No. 60/876,302, filed on Dec. 20, 2006, the entire disclosure of which is incorporated by reference herein.

### BACKGROUND OF THE INVENTION

1. Field of the Invention

The present invention relates to a system and a method for promoting the longevity of a pet through a healthy food regimen that benefits both the pet as well as the pet's owner. Through an assessment of the pet's current health status, a determination is made that a change in the pet's food regimen would promote a longer life span and a healthier vitality. More specifically, a recommended food regimen is determined from the assessment, and the owner is provided with a choice of a plurality of feeding bundles that satisfy the recommended food regimen. For example, the recommended food regimen is determined based on an assessment of the pet's size, breed type, body-fat content, weight, coat condition, sex, life stage, health, and other characteristics indicative of the general well-being of the pet, as well as an assessment of the lifestyle of the pet and the feeding preferences of the pet's owner.

2. Related Art

Pet obesity is one of the leading causes of illness and premature death in pets today. Many pet owners tend to spoil their pets with an overabundance of food and treats, in the mistaken belief that extra food means extra love. Unfortunately, this leads to unhealthy pets that are much heavier than their veterinarian-recommended weight range. Like humans, the excess weight in pets results in a deterioration of the healthy vitality of the pets.

Some pet owners who realize the dangers of pet obesity have tried to remedy this problem by restricting the total amount of food given to their pets. This, however, often results in hungry and unhappy pets. In turn, this leads to unhappy pet owners who feel guilty for starving or depriving their pets.

Some pet owners try to remedy the problem of obesity through use of “diet” pet products, which are low in fat and/or have low caloric content. However, the lack of variety of the diet pet foods has resulted in an unhappy feeding experience for the pet owners, because they cannot vary the types and flavors of food given to their pets without going off the “diet” plan. Moreover, if the pet owners decide to alternate between giving their pets diet food and regular food, the desired weight reduction does not proceed as quickly as it otherwise could.

Pet owners generally want to provide the best nutrition for their pets, but often are constrained by a limited budget. Therefore, some pet owners may opt to purchase premium foods and treats while foregoing supplements in order to stay within their budgets. However, for pets that should be receiving supplements to improve their coats, or for pets that have medical conditions that should be treated with pharmaceuticals, for example, this option is not the best course of action for the well-being of the pets.

For pet owners that are not constrained by pet budgets, their pets often are spoiled by an overabundance of high-calorie treats, as mentioned above. Therefore, these pets may not be receiving foods, supplements, and/or pharmaceuticals that are particularly suited for their conditions. In other words, despite the best intentions of these pet owners, they may not be the most qualified people to determine the best diets for their pets.

Pet owners may have special feeding relationships with their pets, in which the owners have a preferred feeding schedule that is not well suited for the typical container sizes of pet foods offered today. For example, if an owner prefers to feed her cat five or more times per day to coincide with the times when the owner herself eats, the serving size of a typical can of cat food usually is too large to be given in its entirety to the cat for a single feeding. The owner then must serve only a portion of the can and store the remainder for a later feeding. This arrangement can lead to overfeeding of the cat, especially if the owner is overly generous with the feeding portions in order to “finish up” an opened can of cat food.

Many pet owners are uncertain as to the quantity or type of foods (wet and/or dry), treats, supplements, and the like, to give to their pets. As a result of this uncertainty the owners may tend to overfeed their pets or to feed their pets with a type of food that is less than optimal (based on the current conditions of the pets). For example, a sedentary and overweight pet should be receiving low-calorie foods and treats in order to minimize weight gain.

Given the foregoing, a need exists for a convenient way for a pet owner to improve the health and vitality of her pet through a food regimen that is based on characteristics and current conditions of the pet, such as the pet's size, breed type, body-fat content, weight, coat condition, gender, life stage, health, and other characteristics indicative of the general well-being of the pet, as well as the lifestyle of the pet and the pet feeding preferences of the pet's owner.

### BRIEF DESCRIPTION OF THE INVENTION

The present invention meets the above-identified need by providing a method and a system that: assesses a pet's condition using a predetermined assessment scheme; determines feeding preferences of the pet's owner; determines a food regimen suited for improving the pet's condition using an analysis procedure or algorithm established for the assessment scheme, which takes into consideration the owner's feeding preferences (e.g., frequency, type(s) of food, type(s) of snacks, type(s) of supplements, prescribed pharmaceuticals, etc.), the pet's size, breed type, weight, body-fat content, coat condition life stage, health, sex, and other physical characteristics, as well as the lifestyle of the pet (e.g., amount and type of exercise, schedule of physical activity, whether confined to indoors only or has outdoor/outdoor exposure, etc.). The assessment is conducted with the pet and the pet's owner to determine what the current feeding habits of the pet are (e.g., quantity of food, frequency of feeding, type(s) of food (wet and/or dry), preferred flavors, use of treats, use of supplements, etc.).

Preferably, the assessment is conducted by a nutrition consultant or a veterinarian who uses information about the breed type of the pet, a measured body-fat content, and the weight of the pet, for example, to determine the amount of weight the pet should lose (if any). For example, an algorithm may be used to determine a range of products (food (wet and/or dry), treats, supplements, pharmaceuticals) best suited for obtaining weight reduction in the pet without sacrificing quantity or variety. Optionally, cardio tests (e.g., treadmill tests) may be performed on the pet to determine a level of exercise or exertion the pet can safely handle.

According to an aspect of the invention, based on the results of the assessment, a recommended food regimen is determined, which reduces the daily caloric intake of the pet without reducing the quantity of food eaten by the pet. In this way, the pet will not feel hungry or deprived, and the pet owner will not feel guilty about starving her pet. The pet owner is provided with a plurality of options for meeting the recommended food regimen. The plurality of options takes into account the feeding preferences of the owner and enables the owner to diversify the types of food given to the pet. For example, different flavors, shapes, moisture contents, etc., are represented in the plurality of options. The plurality of options also includes options for: natural products, organic products, name-brand products, vegetarian products, etc.

Optionally, together with the recommended food regimen, a recommended lifestyle regimen is provided for the pet, which suggests changes to the pet's exercise routine and suggests how to combine the recommended lifestyle regimen with the recommended food regimen.

The plurality of options for the recommended food regimen includes bundled combinations of food products. A bundled combination includes, for example, any two or more of: pet food(s) (wet and/or dry), pet treats, pet supplements (e.g., vitamins and/or herbal products, etc.), and pharmaceuticals. The items in the bundled combination are determined to be best suited for the pet's well-being and weight-reduction diet based on the assessment and based on the feeding preferences and, optionally, any budget considerations the owner may have.

According to another aspect of the invention, an assessment is made of a current condition of the pet, and a recommended diet is determined based on the assessment. The pet's owner enrolls the pet in a desired feeding plan based on the recommended diet and the owner's pet-maintenance budget. Preferably, the pet's owner enrolls in the feeding plan through a merchant, such as a supermarket for pet-related products or a veterinarian, for example. The owner then obtains the plan's foods/treats/supplements/pharmaceuticals at a convenient predetermined location, such as the merchant's store or the veterinarian's office, for example. Each plan provides, on a periodic basis (e.g., bi-weekly, monthly, etc.), sufficient foods/treats/supplements/pharmaceuticals for the period. The types of foods/treats/supplements/pharmaceuticals provided depends on the results of the assessment for the pet (i.e., the recommended diet). Therefore, if the pet is assessed to have a dull coat, then suitable vitamins and/or other types of supplements may be included in the plan; if the pet is advanced in age, then the plan's food may be food for senior pets; or if the pet has a medical condition, then prescribed pharmaceuticals may be included in the plan.

According to another aspect of the invention, the assessment is performed based on a computerized survey, in which a veterinarian uses a computer to input answers to the survey. Optionally, instead of a veterinarian, a person trained to understand the survey and the process of assessing a pet's condition may perform the assessment. For example, the trained person may be a consultant or an associate (“consultant/associate”) located at the merchant's store or at the veterinarian's office. The survey answers automatically are analyzed according to an algorithm designed to assess the health and well-being of the pet being assessed. The computer then outputs the recommended diet for the pet. Optionally, instead of outputting the recommended diet, the computer may output suggestions for various diets, which the veterinarian or the consultant/associate then discusses with the pet's owner.

According to another aspect of the invention, the assessment is performed manually by the veterinarian, and the veterinarian uses a “recommended-diet notepad” similar to a physician's prescription pad to note the pet's recommended diet and to direct the pet's owner to the merchant's store to determine the desired feeding plan. The notepad may include pre-printed information about the different feeding plans available as well as information about incentives for enrolling in a plan.

According to another aspect of the invention, the assessment is performed by the pet's owner according to a predetermined computerized survey, in which the owner uses a programmed computer to input answers to the survey via an interactive program. That is, involvement by a veterinarian or a consultant/associate is not necessary. The answers inputted by the owner automatically are analyzed according to an algorithm designed to assess the health and well-being of the pet. The computer then outputs the recommended diet for the pet.

According to another aspect of the embodiment, a kiosk or a booth (“kiosk/booth”) at the merchant's store or at the veterinarian's office may be used by the pet's owner to complete the survey to determine the recommended diet for the pet. This way, the owner conveniently may determine the recommended diet, decide on a desired feeding plan, and purchase foods/treats/supplements/pharmaceuticals for the feeding plan all at the same location. Preferably, the kiosk/booth is equipped with a computer or other type of communication device for accessing a server that controls an interactive assessment program for a plurality of kiosks/booths. Optionally, instead of accessing a server, the computer may have the interactive assessment program stored therein.

According to still another embodiment of the invention, assessments of the pet are made over a period of time to determine the efficacy of the recommended diet in maintaining or improving the pet's condition. The assessments are stored in a database and used to refine the program's algorithm for determining future recommended diets.

### BRIEF DESCRIPTION OF THE DRAWING

The features and advantages of the present invention will become more apparent from the detailed description set forth below when considered in conjunction with the attached drawing.

FIG. 1 schematically illustrates a system diagram of an exemplary assessment system used to implement an embodiment of the present invention.

### DETAILED DESCRIPTION OF THE INVENTION

The present invention is directed to a method and a system for promoting the longevity and healthy vitality of a pet through a recommended food regimen. The recommended food regimen is determined by assessing the pet's condition using a predetermined assessment scheme and taking into consideration feeding preferences of the pet's owner. For example, the recommended food regimen is determined by using an analysis procedure or algorithm established for the assessment scheme, which takes into consideration the owner's feeding preferences (e.g., frequency, type(s) of food, type(s) of snacks, type(s) of supplements, prescribed pharmaceuticals, etc.), the pet's size, breed type, weight, body-fat content, coat condition life stage, health, sex, and other physical characteristics, as well as the lifestyle of the pet (e.g., amount and type of exercise, schedule of physical activity, whether confined to indoors only or has outdoor/outdoor exposure, etc.). The assessment is conducted with the pet and the pet's owner to determine what the current feeding habits of the pet are (e.g., quantity of food, frequency of feeding, type(s) of food (wet and/or dry), preferred flavors, etc.).

Preferably, the assessment is conducted by a nutrition consultant or a veterinarian who uses information about the breed type of the pet, a measured body-fat content of the pet, and the pet's weight to determine the amount of weight the pet should lose (if any). For example, an algorithm may be used to determine the range of products (food (wet and/or dry), treats, supplements, pharmaceuticals) best suited for obtaining weight reduction in the pet without sacrificing quantity or variety. Optionally, the assessment includes an exertion test, such as a cardio test (e.g., a treadmill test), for example.

According to an aspect of the invention, based on the results of the assessment, a recommended food regimen is determined, which reduces the daily caloric intake of the pet without reducing the quantity of food eaten by the pet. In this way, the pet will not feel hungry or deprived, and the pet owner will not feel guilty about starving her pet. The pet owner is provided with a plurality of options for meeting the recommended food regimen. The plurality of options takes into account the feeding preferences of the owner and enables the owner to diversify or vary the types of food given to the pet. For example, different flavors, shapes, moisture-content amounts, etc., are represented in the plurality of options. Additionally, the plurality of options includes different types of low-calorie treats for the pet.

Optionally, together with the recommended food regimen, a recommended lifestyle regimen is provided for the pet, which suggests changes to the pet's exercise routine and suggests how to combine the recommended lifestyle regimen with the recommended food regimen.

The plurality of options for the recommended food regimen includes bundled combinations of food products. A bundled combination includes, for example, any two or more of: pet food(s) (wet and/or dry), pet treats, pet supplements (e.g., vitamins and/or herbal products, etc.), and pharmaceuticals. The items in the bundled combination are determined to be best suited for the pet's well-being and weight-reduction diet based on the assessment and based on the feeding preferences and, optionally, any budget considerations the owner may have.

The plurality of options allows the pet owner not only to help the pet lose weight and improve longevity through a low-calorie, nutritionally sound diet, but also allows the pet owner to feel a sense of contentment that the recommended regimen does not cause the pet to go hungry or be bored with the same type of low-calorie food all the time. That is, because the plurality of options allows the pet owner to choose from different flavors, shapes, textures, moisture contents, etc., the pet owner generally will feel that she is doing the best she can for her pet to be happy and healthy and live a long life.

Optionally, a series of assessments may be performed on the pet over a period of time to determine how well the pet is improving under the recommended food regimen. This enables the recommended food regimen to be “tweaked” or adjusted in accordance with observations made in the second and subsequent assessments.

The assessment may be performed in a veterinarian's office or in an area of a pet-food market. Preferably, a trained nutrition consultant or a veterinarian performs the assessment. For a pet of a known breed, information is obtained regarding standard ranges of body-fat content and weight for that breed. As part of the assessment, the pet's characteristics are compared with the standard body-fat and weight ranges as well as other information known about that breed. Optionally, the pet is given a cardio test to determine how his or her body responds to exercise. From the cardio test, a determination can be made of the level of exercise the pet can start at in order to further promote weight reduction, in addition to weight reduction from the reduced calorie intake of the recommended food regimen. As mentioned above, a series of assessments may be performed over a period time, which allows the level of exercise recommended for the pet to be modified in accordance with improvements or other changes to the pet's condition.

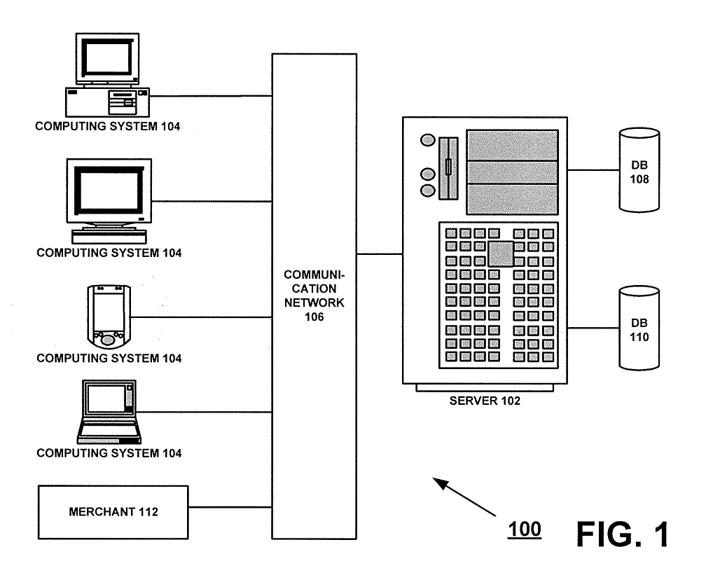

FIG. 1 shows a schematic system diagram of an exemplary assessment system 100, used to implement or practice one or more embodiments of the present invention. System 100 includes a server 102 interconnected with one or more computing systems 104 via a communication network 106. Server 102 has access to a plurality of databases in/from which information is stored/retrieved, such as an assessment-results database 108, which identifies each pet for which an assessment has been performed and stores the assessment results for the pets, and a recommended-diets database 110, which stores a plurality of diet plans each corresponding to an assessment result, for example. Communication network 106 may be the Internet, a public switched telephone network (PSTN), or any other means of communication between server 102 and computing system(s) 104, whether wired or wireless. Computing system 104 may be used by a veterinarian or a trained assessment consultant/associate to communicate with server 102, and may be a personal computer, a workstation, a mainframe computer, a kiosk, a personal digital assistant, or any other digital device able to perform data communication with server 102. Server 102 is programmed to provide an interactive assessment survey to computing system 104, to analyze inputted survey answers, and to provide recommendations according to analysis results.

The assessment survey may be downloaded from server 102 to computing system 104, such that the assessment survey is resident on a hard drive of computing system 104. Optionally, the assessment survey may be loaded in a memory of computing system 104 via a computer-readable storage medium (e.g., a DVD, a CD, etc.) without the need to access server 102.

The assessment survey enables a current condition of the pet to be assessed, based on answers provided to queries in the survey. Additionally, the survey obtains information on feeding preferences of the pet's owner, including preferred: frequency of feedings (e.g., once daily; five-times per day; wet food twice daily and dry food once daily; etc.), type(s) of food (e.g., wet food, dry food, only natural food(s), a combination of natural and regular foods, etc.), use of particular products for treats (e.g., use of oral-care dry food as treats, etc.), for example. The term “natural,” as used herein, generally refers to foods that have by-product specifications established by the AAFCO, as will be appreciated by persons skilled in the art. A recommended diet is determined based on the assessment. (As used herein, the term “diet” includes any combination of foods (wet and/or dry), treats, supplements, and pharmaceuticals). The pet's owner enrolls the pet in a desired feeding plan based on the recommended diet and, optionally, the owner's pet-maintenance budget. For example, for a modest-budget feeding plan (e.g., a “Bronze Plan”), the recommended diet includes a combination of standard foods/treats/supplements/pharmaceuticals chosen to maintain or improve the pet's condition; for a high-budget feeding plan (e.g., a “Platinum Plan”), the recommended diet includes premium foods/treats/supplements/pharmaceuticals chosen to maintain or improve the pet's condition. As will be appreciated by persons of skill in the art, feeding plans for other budget levels also may be available and within the scope of the present invention (e.g., a “Gold Plan,” a “Silver Plan,” etc.).

As used herein, the term “foods/treats/supplements/pharmaceuticals” is intended to indicate any combination of two or more of the four categories of feeding-plan products (i.e., foods (wet and/or dry) and treats; foods, treats, and pharmaceuticals; foods, treats, and supplements; etc.); the combination is not required to include all four categories of products. Preferably, the combination includes food (wet and/or dry) and at least one other category of feeding-plan products.

The pet's owner enrolls in the feeding plan through a merchant 112, such as a supermarket for pet-related products. The owner then obtains the plan's foods/treats/supplements/pharmaceuticals at a convenient predetermined location, such as the merchant's store. The owner is given an incentive by merchant 112 to enroll in the plan and to make repeat purchases of the plan's foods/treats/supplements/pharmaceuticals from the merchant's store. For example, the incentive may be that the total cost to the owner of the food/treats/supplements if purchased as a bundle under the plan would be less than the cumulative cost to the owner of the food/treats/supplements/pharmaceuticals if purchased separately (e.g., the fixed cost for a purchase under the plan gives the owner a discount of 30%, for example, for the combined purchase of the foods/treats/supplements/pharmaceuticals); or the incentive may be a discount card that enables every fifth bundled purchase under the plan to receive a discount of, for example, 50%. In another example, the incentive may be to provide the owner with a gift for signing on to purchase periodic bundles for a term of, for example, one year. Other types of loyalty incentives are also contemplated.

As will be appreciated by persons of skill in the art, and as discussed above, pharmaceuticals need not be included in the plan, especially if merchant 112 is not licensed to dispense pharmaceuticals. However, if the plan is purchased from a veterinarian who is licensed to dispense pharmaceuticals, then the plan may include pharmaceuticals.

Each plan provides, on a periodic basis (e.g., bi-weekly, monthly, etc.), sufficient foods/treats/supplements/pharmaceuticals for the period. For example, a monthly Bronze Plan for a cat may provide a month's supply of standard dry and/or wet cat food, a container of about 60 standard treats (suitable for about 2 treats per day), a month's supply of standard vitamins and/or other types of supplements, and if necessary a month's supply of generic pharmaceuticals for treating a heart condition. Similarly, for a monthly Platinum Plan, a month's supply of premium dry and/or wet cat food, a month's supply of premium treats, a month's supply of premium supplements, and a month's supply of name-brand pharmaceuticals may be included in the plan. The types of foods/treats/supplements/pharmaceuticals provided depends on the results of the assessment for the cat (i.e., the recommended diet, which takes into account the feeding preferences of the pet's owner). Therefore, if the cat is assessed to have a dull coat, then suitable vitamins and/or other types of supplements may be included in the plan; if the cat is advanced in age, then the plan's food may be food for senior cats; if the owner prefers only natural foods, then the plan may include only natural foods; if the owner prefers natural and/or indulgent foods, then the plan may include one or both of natural foods and indulgent foods; and if the cat requires pharmaceuticals, then the plan may include suitable pharmaceuticals.

If the assessment determines that the feeding preferences of the pet's owner is to feed the pet small quantities of wet food several times (e.g., five or more times) per day, then the feeding plan may include small single-serving wet-food pouches that avoids the need for the owner to store opened cans of partially used food. This feature removes the uncertainty the owner may have about the appropriate amount of food to feed the pet, especially when the pet is fed several times per day, and also removes the uncertainty of whether the proper food is being given to the pet. As a consequence, the feeding plan enhances the owner's feeding experience by removing anxiety and guilt from the feeding experience.

According to an embodiment of the invention, the assessment is performed based on a computerized survey, in which a veterinarian uses a computer to input answers to the survey. The answers automatically are analyzed according to an algorithm designed to assess the health and well-being of the pet under observation. The computer then outputs the recommended diet for the pet. Optionally, instead of a veterinarian, a person trained to understand the survey and the process of assessing a pet's condition may perform the assessment, such as a consultant/associate located at the merchant's store or at the veterinarian's office.

The computerized assessment survey may be in the form of an interactive program stored locally in a memory unit of computing system 104 and executed by a microprocessor of computing system 104. That is, the program may be locally installed in a computer used by the veterinarian or the consultant/associate without requiring that the computer be in communication with server 102. This allows the veterinarian or the consultant/associate to perform “mobile” pet assessments using, for example, a laptop at any desired location (e.g., a shopping mall), which may not provide an easy way for the laptop to connect to a communication network. If desired, results from such mobile assessments may later be uploaded to server 102 so that they may be stored in database 108. As will be appreciated by persons of skill in the art, when the program is locally installed in computers used by veterinarians or consultants/associates, a plurality of diet plans each corresponding to an assessment result is stored locally in the computers in association with the locally-installed program.

Alternatively, as mentioned above, the interactive program may be stored off-site in a memory unit accessible by server 102 and shared (accessible) by other computing systems 104, and is accessible by each computing system 104 through communication network 106. The program provides an electronic user interface that queries the veterinarian or the consultant/associate to provide responses to survey questions about the pet being examined. Once the responses have been entered, via computing system 104, the program uses the responses in an algorithm to determine the recommended diet or to provide suggestions for various diets, which are discussed with the pet's owner before a plan is chosen.

Preferably, the veterinarian or the consultant/associate encourages the pet's owner to enroll the pet in a feeding plan by informing the owner of the benefits to the pet of a combined regimen of the plan's foods/treats/supplements/pharmaceuticals, and by informing the owner of the savings the owner would be entitled to if the plan's foods/treats/supplements/pharmaceuticals are purchased together in a bundle from merchant 112 than if purchase separately. According to one option, computing system 104 transmits information on the pet and the pet's recommended diet to a computer at the merchant's store for the convenience of the pet's owner. Then, when the owner goes to the merchant's store, a feeding-plan consultant discusses various feeding-plan options (e.g., Bronze Plan, Platinum Plan, etc.) with the owner and determines the desired feeding plan for the pet. The owner then purchases the plan's foods/treats/supplements/pharmaceuticals on a periodic basis or as needed from the merchant's store. According to another option, computing system 104 transmits information on the pet, the pet's recommended diet, and the desired feeding plan to a computer at the merchant's store for the convenience of the pet's owner. Then, the owner can purchase the plan's foods/treats/supplements/pharmaceuticals on a periodic basis or as needed from the merchant's store.

According to another embodiment of the invention, the assessment is performed manually and the veterinarian uses a “recommended-diet notepad” similar to a physician's prescription pad to note the pet's recommended diet and to direct the pet's owner to the merchant's store to determine the desired feeding plan. The notepad may include pre-printed information about the different feeding plans available as well as information about incentives for enrolling in a plan, as discussed above.

According to yet another embodiment of the invention, various aspects of the computerized survey and the manual assessment may be combined.

According to a further embodiment of the invention, the assessment is performed by the pet's owner according to a predetermined computerized assessment survey, in which the owner uses computing system 104 to input answers to the survey. That is, involvement by a veterinarian or a consultant/associate is not necessary. The answers inputted by the owner automatically are analyzed according to an algorithm designed to assess the health and well-being of the pet being assessed. The computer then outputs the recommended diet for the pet.

The assessment survey may be in the form of an interactive program stored in a memory unit accessible by server 102 and shared (accessible) by pet owners, veterinarians, pet caretakers, and the like, through computing systems 104 communicating over communication network 106. The program provides an electronic user interface that queries the pet owner to provide responses to survey questions about the pet being assessed. Once the responses have been entered, the program uses the responses in an algorithm to determine the recommended diet.

Preferably, the program presents the pet's owner with information encouraging enrollment of the pet in a feeding plan offered by the merchant by informing the owner of the benefits to the pet of a combined regimen of the plan's foods/treats/supplements/pharmaceuticals, and by informing the owner of the savings the owner would be entitled to if the plan's food/treats/supplements are purchased together from merchant 112 than if purchase separately. Then, when the owner goes to the merchant's store, a feeding-plan consultant discusses various feeding-plan options (e.g., Bronze Plan, Platinum Plan, etc.) with the owner and determines the desired feeding plan for the pet. The owner then purchases the plan's foods/treats/supplements on a periodic basis or as needed, as discussed above.

According to an aspect of the embodiment, a kiosk/booth at the merchant's store or at the veterinarian's office may be used by the pet's owner to complete the survey to determine the recommended diet for the pet. This way, the owner conveniently may determine the recommended diet, decide on a desired feeding plan, and purchase foods/treats/supplements/pharmaceuticals for the feeding plan all at the same location. Preferably, the kiosk/booth is equipped with a computer or other type of communication device (e.g., computing system 104) for accessing server 102, which controls an interactive assessment program for a plurality of kiosks/booths.

According to still another embodiment of the invention, assessments of the pet are made over a period of time to determine the efficacy of the recommended diet in maintaining or improving the pet's condition. The assessments are stored in database 110 and used to refine the program's algorithm for determining future recommended diets.

The various embodiments of the present invention described above have been presented by way of example and not limitation. It will be apparent to persons skilled in the relevant arts that various changes in form and detail can be made therein without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawing, which highlights the functionality and advantages of the present invention, are presented as an illustrative example. The system arrangement of the present invention is sufficiently flexible and configurable, such that it may be utilized and configured in ways other than that shown in the drawing.

What is claimed is:

1. A method of promoting longevity and a healthy vitality of a pet, comprising:
performing an assessment of a condition of the pet;
determining a lifestyle of the pet;
determining pet feeding pet preferences of the pet's owner;
determining a recommended food regimen for improving the condition of the pet, based on the assessment, the lifestyle, and the pet feeding preferences; and
providing a plurality of options for satisfying the food regimen,
wherein the plurality of options includes a plurality of bundled combinations.

2. The method of claim 1, wherein the assessment includes a measurement of a body-fat content of the pet or a determination of a weight of the pet or both.

3. The method of claim 1, wherein the lifestyle of the pet includes at least one of: an activity level of the pet, a type of exercise performed by the pet, whether the pet is allowed outdoors, whether the pet is sedentary, whether the pet is handicapped, whether one or more other pets cohabit with the pet.

4. The method of claim 1, wherein the assessment includes an exercise test.

5. The method of claim 4, wherein the exercise test is a test to determine a heart condition.

6. The method of claim 4, wherein the exercise test enables a determination of a level of exercise the pet can handle.

7. The method of claim 1, wherein the recommended food regimen includes a recommended daily calorie intake for the pet.

8. The method of claim 1, wherein the recommended food regimen includes a recommended quantity of specific foods and treats.

9. The method of claim 1, wherein the plurality of options includes options for one or more of: natural (AAFCO) products, organic products, brand types, flavor types, budget levels, nutritional contents, texture types, types of fillers, vegetarian products.

10. The method of claim 1, further comprising:
performing a plurality of assessments of the condition of the pet over a period of time during which the pet is on the recommended food regimen; and
refining the recommended food regimen based on the plurality of assessments.

11. A method of improving an enjoyment level of a pet feeding experience of a pet owner, comprising:
performing an assessment of a condition of a pet;
determining a lifestyle of the pet;
determining pet feeding preferences of the pet's owner;
determining a recommended food regimen for improving the condition of the pet, based on the assessment, the lifestyle, and the pet feeding preferences; and
providing a plurality of feeding plans for satisfying the food regimen,
wherein each of the plurality of feeding plans includes a reduced-calorie food product.

12. The method of claim 11, wherein the recommended food regimen allows the pet to consume a quantity of food similar to a previous quantity of food consumed by the pet, but reduces a calorie intake of the pet compared with a calorie intake corresponding to the previous quantity of food.

13. The method of claim 12, wherein calorie reduction is achieved by reducing a percentage of fat in the food, increasing a quantity of water in the food, or both.

14. The method of claim 11, wherein the plurality of options includes options for one or more of: natural (AAFCO) products, organic products, brand types, flavor types, budget levels, nutritional contents, texture types, types of fillers, vegetarian products.

15. The method of claim 11, wherein the pet feeding experience of the pet owner is improved by allowing the pet owner to select from a variety of different food products for the pet that improves the condition of the pet

16. The method of claim 11, wherein the pet feeding experience of the pet owner is improved by the pet owner observing the pet enjoy a food product from a selected feeding plan.

17. The method of claim 11, further comprising:
performing a plurality of assessments of the condition of the pet over a period of time during which the pet is on the recommended food regimen; and
refining the recommended food regimen based on the plurality of assessments.
